(19) United States
(12) Patent Application Publication
(10) Pub. No.: US 2013/0151272 A1
(43) Pub. Date: Jun. 13, 2013

(54) METHOD AND SYSTEM FOR SCHEDULING DEMAND-RESPONSE TRANSIT SERVICE

(71) Applicant: Roelof VIS, Eastern Passage (CA)

(72) Inventor: Roelof VIS, Eastern Passage (CA)

(73) Assignee: TRAPEZE SOFTWARE INC., Mississauga (CA)

(21) Appl. No.: 13/400,051

(22) Filed: Feb. 18, 2012

(30) Foreign Application Priority Data
Dec. 8, 2011 (CA) 2761369

(51) Int. Cl. G06Q 50/22

(52) U.S. Cl. 705/2

(57) ABSTRACT

A method and system for scheduling home health care visits are provided. Client data for a set of clients, home health care professional data for a set of home health care professionals, and a resource schedule for the set of clients and the set of home health care professionals are stored in storage of a computer system. The resource schedule is determined to have become unsuitable. A change to the resource schedule in response to the determining is identified. The change to a transit-scheduling server to make a revision to a transit schedule is automatically communicated. Confirmation of the revision of the transit schedule is received. The resource schedule is revised in response to the receipt of the confirmation.

### FIELD OF THE INVENTION

The present invention relates generally to information systems. In particular, the invention relates to a method and system for scheduling demand-response transit service.

### BACKGROUND OF THE INVENTION

Demand-response trip scheduling is known. A customer contacts a transit operator that offers demand-response transit service and makes a trip request. The trip request includes parameters such as a departure location, a destination and a desired departure time. The transit organization may maintain data for the customer regarding specific needs that the customer has, benefit plans that may cover some or all of the costs of the trip, etc.

Demand-response transit is often utilized by home health care organizations. These organizations employ home health care professionals to make home visits to clients requiring home health care. Typically, these organizations are compensated for the provisioning of such service via fee-for-service funding via health care programs such as Medicaid and the Veterans Administration. A portion of this funding is spent transporting home health care professionals to and from the homes of clients for these visits.

Home health care professionals employed by a home health care organization generally have different skills and abilities (referred to hereinafter as “skills”). Some may be registered nurses, some may be qualified to provide cleaning and bathing assistance to elderly or physically-challenged clients, some may speak a second language such as Spanish fluently, some may be qualified physiotherapists, etc. Other skills may include, for example, speech therapists and counselors. Likewise, clients generally require different types of home care. Some clients may require the attendance of a registered nurse, others may require physiotherapy and others may require assistance with bathing. A home health care organization matches clients requiring home care visits with home health care professionals that possess the requisite skills to serve them.

Further, some clients may have circumstances that may limit the home health care professionals that can serve them. For example, some clients may not feel comfortable with a home health care professional of the opposite sex providing them service. Other clients may have dogs that may scare some home health care professionals. Still other clients requiring physical assistance may require a home health care professional possessing above-average strength.

Matching clients with home health care professionals is traditionally done via pencil and paper. In the case of some larger home health care organizations serving larger metropolitan areas, skill-based resource-scheduling software is used to schedule home health care workers to service home visits. Such skill-based resource-scheduling software can generate a schedule upon receipt of various inputs. These inputs can include, for each home health care professional, their skills, characteristics, and schedule availability. For each client event (i.e., visit), these inputs can include their name, medical and vital information, residential address, languages spoken, home health care required, plan coverage (if any), pets, preferences, etc.

Once a schedule is set, the home health care organization contacts a demand-response transit operator to schedule trips to transport the home health care professionals scheduled to make the visits.

During the course of a day or week, deviations in the home health care schedule can occur. For example, a home health care professional may call in sick, forcing the home health care organization to reschedule the visit for a different professional and/or time, or even cancel the visit altogether. A client may cancel an appointment for various reasons. When such deviations in the home health care schedule occur, they must be communicated to the demand-response transit operator to reschedule or cancel the scheduled trips. Such rescheduling of the trips can be expensive, requiring one or more agents of the home health care organization to negotiate with the demand-response transit operator. If the telephone lines of the transit operator are occupied, the calls must be re-placed later, making them prone to incompletion.

Demand-response transit is generally very cost-sensitive. When trip request changes resulting from changes to the home health care schedule have not been properly communicated to the demand-response transit operator, the demand-response schedule may ultimately include trips for home health care visits that have been cancelled, delayed, etc. As a result, the vehicles operated by the demand-response transit operator can experience unnecessary delays and idling. Even worse, the vehicles may be scheduled to stop to make a pick-up for a trip that is no longer required. As a result, the efficiency of the service provided by the demand-response transit operator can suffer.

It is therefore an object of the invention to provide a novel method and system for scheduling demand-response service.

### SUMMARY OF THE INVENTION

According to an aspect of the invention, there is provided a computer system for scheduling home health care visits, comprising:

storing, in storage of a computer system, client data for a set of clients, home health care professional data for a set of home health care professionals, and a resource schedule for said set of clients and said set of home health care professionals;

determining that said resource schedule has become unsuitable;

identifying a change to said resource schedule in response to said determining;

automatically communicating said change to a transit-scheduling server to make a revision to a transit schedule;

receiving confirmation of said revision of said transit schedule; and

revising said resource schedule in response to said receiving said confirmation.

The determining can include receiving a cancellation request for a home visit.

The determining can include determining that a client scheduled for a home visit will miss the home visit. The method can further include:

receiving a geolocation of said client from a mobile device associated with said client; and

determining if said client is able to arrive at the location of said home visit at the time of said home visit.

The determining can include determining that a home health care professional scheduled for a home visit will miss the home visit.

The method can further include:

receiving a geolocation of said home health care professional from a mobile device associated with said home health care professional; and

determining if said home health care professional is able to arrive at the location of said home visit at the time of said home visit.

The determining can include receiving a notification from the transit-scheduling server that a scheduled trip has been one of cancelled and delayed.

The revision can be associated with at least one trip. The method can further include communicating the revision of the transit schedule to one of the home health care professionals and one of the clients associated with the at least one trip.

The determining comprises identifying a home visit to be scheduled. The automatically communicating can include communicating an identifier of a client for the home visit. The method can further include:

revising said change to said resource schedule when said revision is unconfirmed; and

automatically communicating said revised change to said transit-scheduling server to make a revision to said transit schedule.

According to another aspect of the invention, there is provided a system for scheduling home health care visits, comprising:

a computer system comprising:
storage storing client data, home health care professional data, a resource schedule and computer-executable instructions for resource-scheduling software;
a communications interface; and
a processor executing said computer-executable instructions and determining that said resource schedule has become unsuitable, identifying a change to said resource schedule, automatically communicating said change to a transit-scheduling server via said communications interface to make a revision to a transit schedule, receiving confirmation of said revision of said transit schedule via said communications interface, and revising said resource schedule in response to said receiving said confirmation.

The processor can determine that the resource schedule has become unsuitable upon receiving a cancellation request for a home visit.

The processor can determine that the resource schedule has become unsuitable upon determining that a client scheduled for a home visit will miss the home visit. The system can further include:

a mobile device having geolocation-determining technology, said mobile device executing an application for relaying a geolocation determined using said geolocation-determining technology to said computer system,

and wherein said processor of said computer system determines if said mobile device is able to arrive at the location of said home visit at the time of said home visit.

The processor can determine that the resource schedule has become unsuitable upon determining that a home health care professional scheduled for a home visit will miss the home visit. The system can further include:

a mobile device having geolocation-determining technology, said mobile device executing an application for relaying a geolocation determined using said geolocation-determining technology to said computer system,

and wherein said processor of said computer system determines if said mobile device is able to arrive at the pick-up location of a trip to determine if said resource schedule has become unsuitable.

The processor can determine that the resource schedule has become unsuitable upon receiving notification from the transit-scheduling server that a scheduled trip has been one of cancelled and delayed.

The revision can be associated with at least one trip. The processor can communicate the revision of the transit schedule to one of the home health care professionals and one of the clients associated with the at least one trip.

The system can further include a mobile device executing an application enabling a user thereof to request the cancellation or delay of a home visit, the mobile device transmitting the cancellation or delay request to the computer system.

The processor can request adjustment of a trip of the transit schedule to a different destination as a result of the cancellation of a home visit.

The processor can request adjustment of a trip of the transit schedule from a different origin as a result of the cancellation of a home visit.

The system can further include:

a mobile device having geolocation-determining technology, said mobile device executing an application for intermittently relaying a geolocation determined using said geolocation-determining technology to said computer system,

and wherein said processor of said computer system logs said geolocation.

The processor can track transit expenditures for clients and benefit plans.

According to a further aspect of the invention, there is provided a system for scheduling home health care visits, comprising:

a mobile device having geolocation-determining technology, said mobile device executing an application for enabling a user thereof to register the geolocation determined using said geolocation-determining technology at the start and end time of a home visit, and for relaying said start and end times together with said geolocations; and

a computer system receiving and registering said start and end times together with said geolocations.

### BRIEF DESCRIPTION OF THE DRAWINGS

Embodiments will now be described, by way of example only, with reference to the attached Figures, wherein:

FIG. 1 shows a schematic diagram for a system for scheduling demand-response transit service in accordance with an embodiment of the invention and its operating environment;

FIG. 2 shows various logical components of the transit-scheduling server of FIG. 1; and

FIG. 3 shows the general method of scheduling visits of home health care professionals to the homes of clients for a time period.

### DETAILED DESCRIPTION OF THE EMBODIMENTS

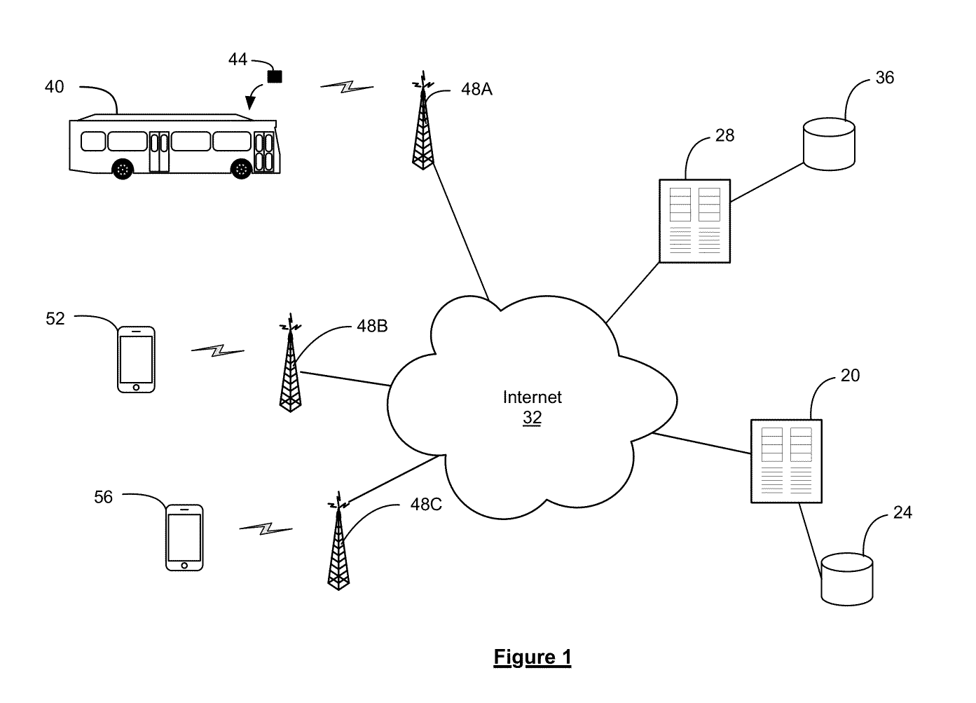

FIG. 1 is a schematic diagram showing a number of physical and logical components of a transit-scheduling server 20 for scheduling demand-response transit service and its operating environment in accordance with an embodiment of the invention. The transit-scheduling server 20 is a computer system that includes one or more physical computers that cooperatively provide scheduling functionality for a demand-response transit operator. In particular, the transit-scheduling server 20 generates and maintains a demand-response transit schedule in a demand-response transit schedule database 24. The demand-response transit schedule includes trips that were booked and scheduled for various parties, including home health care professionals.

The transit-scheduling server 20 is in communication with a resource-scheduling server 28 via a communications network such as the Internet 32. The resource-scheduling server 28 executes skill-based resource-scheduling software for managing the scheduling of skill-based resources, and maintains a skill-based resource schedule in a resource schedule database 36. The resource-scheduling server 28 may be operated by the transit operator operating the transit-scheduling server 20 or by an independent party.

A transit vehicle 40 is shown. The transit vehicle 40 has an on board unit (“OBU”) 44, commonly referred to as a “black box”, that collects and transmits automatic vehicle location (“AVL”) data to the transit-scheduling server 20. The OBU 44 includes an engine interface, such as a controller area network bus (“CANbus”) interface, for receiving metrics from the engine. The metrics include the speed of the vehicle, the distance traveled (odometer deltas), fuel usage, brake pedal position, throttle position and idle time. A global positioning system (“GPS”) module of the OBU 44 registers the geolocation, as latitude and longitude coordinates, of the OBU 44 and, hence, the vehicle 40 in which the OBU 44 is installed. In addition, the OBU 44 has a user interface that includes a touch panel, and storage. The OBU 44 receives an itinerary from the scheduling server 20 and stores it in storage. The touch panel then presents the itinerary, or a portion thereof, to a driver to direct the driver along a run to provide a set of trips to passengers. The touch panel also includes a set of soft keys that allow the driver to indicate that a passenger has been picked up, is a no-show, etc. The OBU 40 also includes a cellular communications interface for communicating with the transit-scheduling server 20 over the Internet 32 via a cellular base station 48A. The cellular base station 48A is coupled to the Internet 32 via a number of intermediate proxies and servers that form part of the infrastructure of a cellular communications carrier (not shown). The OBU 44 transmits the AVL data, which includes the time and date, geolocation, speed and direction of the vehicle, together with any inputs received from the driver, to the transit-scheduling server 20 at regular time intervals to enable the transit-scheduling server 20 to have relatively-current knowledge of the location of the transit vehicle 40. Further, the OBU 44 receives itineraries or revisions thereto from the transit-scheduling server 20 via the cellular communications interface.

The transit-scheduling server 20 aggregates the AVL and other data received from the OBUs 44 on the vehicles 40, together with other information provided from operational dispatch when one or more of the following events occurs:

modifying times of scheduled work assignment to reflect service demands;

real time operational events such as accidents, incidents & vehicle delays;

driver and vehicle assignments (e.g., driver and vehicle assignments are changed when a driver calls in sick, a vehicle breaks down, or unscheduled service needs to be met); and

cancellation of trips (changes to the scheduled service based on events such as lack of drivers, equipment, inclement weather or other service day incidents).

A first mobile device 52 is in communication with the resource-scheduling server 28 via a cellular base station 48B coupled to the Internet 32. The mobile device 52 is carried by a home health care professional and executes a home health care application. The home health care application retrieves the geolocation of the mobile device 52 determined either via Global Positioning System (“GPS”), via WiFi-assisted GPS or some other geolocation-determining technology. The mobile device 52 can actively transmit its geolocation to the resource-scheduling server 28 with regular frequency or when a distance change threshold is exceeded. Alternatively, the mobile device 52 may be polled by the resource-scheduling server 28 to provide its geolocation. The identity of each mobile device 52 is registered with the resource-scheduling server 28 and is associated with the home health care professional that uses it. As a result, the resource-scheduling server 28 is able to determine the location of each home health care professional from the mobile devices 42, by association. Additionally, the home health care application enables the home health care professional to signal the start and end of a home heath care event (e.g., a home visit). The home health care application communicates the geolocation and time, together with the event start or end information, to the resource-scheduling server 28.

A second mobile device 56 similar to the first mobile device is in communication with the resource-scheduling server 28 via a cellular base station 48C coupled to the Internet 32. The mobile device 56 is carried by a client that requires home health care and executes a client application. The client application retrieves the geolocation of the mobile device 56 determined either via GPS, via WiFi-assisted GPS or some other geolocation-detection technology. The mobile device 56 can actively transmit its geolocation to the resource-scheduling server 28 with regular frequency or when a distance change threshold is exceeded. Alternatively, the mobile device 56 may be polled by the resource-scheduling server 28 to provide its geolocation. The identity of each mobile device 56 is registered with the resource-scheduling server 28 and is associated with the client that uses it. As a result, the resource-scheduling server 28 is able to determine the location of each client from the mobile devices 42, by association.

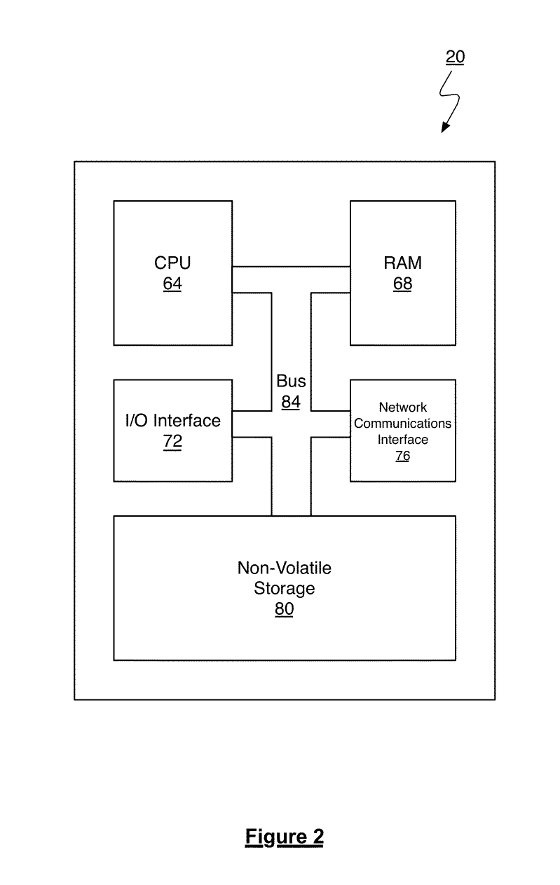

FIG. 2 shows various physical elements of the transit-scheduling server 20. As shown, the transit-scheduling server 20 has a number of physical and logical components, including a central processing unit (“CPU”) 64, random access memory (“RAM”) 68, an input/output (“I/O”) interface 72, a network communications interface 76, non-volatile storage 80, and a local bus 84 enabling the CPU 64 to communicate with the other components. The CPU 64 executes an operating system and demand-response transit-scheduling software. RAM 68 provides relatively-responsive volatile storage to the CPU 64. The I/O interface 72 allows for input to be received from one or more devices, such as a keyboard, a mouse, etc., and outputs information to output devices, such as a display and/or speakers. The network communications interface 76 permits communication with other systems. Non-volatile storage 80 stores the operating system and programs, including computer-executable instructions for implementing the demand-response transit-scheduling software, and data used by the software, such as the demand-response transit schedule database. During operation of the transit-scheduling server 20, the operating system, the computer-executable instructions and the data may be retrieved from the non-volatile storage 80 and placed in RAM 68 to facilitate execution.

The demand-response transit-scheduling software includes a trip-booking module for handling the scheduling, editing and cancellation of trips for clients, an itinerary-planning module for generating itineraries for the booked trips, and a graphical user interface for providing a dashboard to enable an administrator to review the operation of the demand-response transit-scheduling software.

The resource-scheduling server 28 is similar to the transit-scheduling server 20 in physical configuration, but executes skill-based resource-scheduling software. The skill-based resource-scheduling software performs scheduling for home health care professionals to visit clients requiring services. To this end, the skill-based resource scheduling software stores client data and resource data in the resource schedule database 36.

When a client is registered for service with a home health care organization, relevant information about the client is collected. The following information may be collected from a client:

names (first, middle, last, title, nickname)

date of birth

residential address

telephone numbers

emergency contact(s)

medical conditions

health care coverage information

gender

pets, if any

scheduled services required (cleaning, bathing, physical and occupational therapy, speech therapy, specialized nursing, etc., as well as a desired and required schedule for these services)

preferred gender of health care professional

preferred language(s)

special needs

availability schedule (for receiving home visits)

The resource-scheduling server 28 generates a client ID for the client and stores it, together with the collected client information, in the resource schedule database 36.

Additionally, the client may be provided with the mobile device 56 where he or she does not already possess a suitable device. The mobile device 56 executes a client application for allowing the client to interact with the resource-scheduling server 28. In particular, the client application enables both the client and the home health care organization to schedule and reschedule visits.

Home health care professionals within the home health care organization are also registered with the resource-scheduling server 28. The following information may be collected for each home health care professional:

names (first, middle, last, title, nickname)

residential address

telephone numbers

gender

pet tolerance/comfort

languages spoken

skills (bathing, cleaning, nurse and other qualifications, etc.)

availability schedule

The home health care professionals are equipped with mobile devices 52 for interacting with the resource-scheduling server 28.

Scheduled visits of home health care professionals to the homes of clients are registered in the resource schedule database 36.

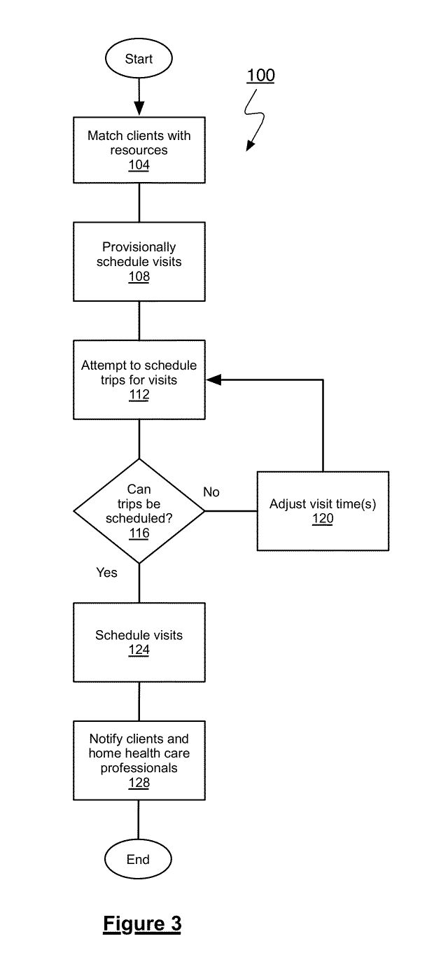

FIG. 3 is a flowchart of the generally method 100 employed by the resource-scheduling server 28 and the transit-scheduling server 20 for scheduling visits of home health care professionals to the homes of clients for a time period. Using the data for both the client and home health care professionals, the skill-based resource-scheduling software matches home health care professionals to clients (104). Various characteristics for the clients and the home health care professionals are compared during the matching, including:

clients' scheduled services required versus home health care professionals' skills

clients' availability schedules versus home health care professionals' availability schedules

the location of clients' homes versus those of health care professionals

clients' preferred languages versus home health care professionals' spoken languages

clients' preferred genders of health care professionals versus the genders of the home health care professionals

clients' pets versus home health care professionals' pet tolerance/comfort

In addition, the home health care professionals' scheduled visits stored in the resource schedule database 36 are also taken into consideration.

In some cases, it can be desirable to match a client with a single home health care professional as the client may be more comfortable with repeat visits by the same one or few professionals.

The resource-scheduling server 28 can be provided home visit schedule requirements for a client that it can enforce. For example, if a client should receive a particular service, therapy, etc. with a specified frequency at minimum, the resource-scheduling server 28 can take the schedule requirements into consideration when scheduling home visits.

When the skill-based resource-scheduling software has matched clients with home health care professionals, it provisionally schedules the visits of the home health care professionals (108). The scheduled visit fits within the constraints specified by both the client and the home health care professional. Adjustments can be made manually where a client cannot be matched with an appropriate home health care professional by the resource-scheduling server 28.

Once a skill-based resource schedule is provisionally set, the resource-scheduling server 28 attempts to schedule trips for the visits (112). The resource-scheduling server 28 sends trip requests to the transit-scheduling server 20 for each leg of each visit. That is, the resource-scheduling server 28 generates trip requests to transport home health care professionals from their expected prior locations (such as the homes of other clients or their own homes) to the homes of the clients, scheduled to arrive at the visit start times, and from the homes of the clients to the locations of a next visits or to the home health care professionals' homes after the visits are scheduled to end. The trip requests in this case include an identification of the client.

The transit-scheduling server 20 determines if it can schedule the requested trips (116). In particular, the transit-scheduling server 20 attempts to schedule each requested trips, but may not be able to schedule them all. Some trips may not be scheduled due to a shortage of vehicles and/or vehicle operators, a lack of space on those vehicles scheduled to travel in the area of the requested trips, etc. Additionally, the transit-scheduling server 20 ensures that each proposed home visit does not fall between the pick-up time and the drop-off time at the associated client's home for trips booked for the client. That is, the transit-scheduling server checks to ensure that the client is scheduled to be at home at the proposed time of the home visit. In response, the transit-scheduling server 20 confirms those trips that it can schedule and identifies those trips that it cannot schedule.

If some trips cannot be scheduled, the resource-scheduling server 28 adjusts the visit times (120). Once the visit times have been adjusted, the resource-scheduling server 28 attempts to schedule the trips for the visits at 112.

Once the trips are scheduled by the transit-scheduling server 20, the resource-scheduling server 28 schedules the visits (124). That is, once transportation for the home health care professionals has been scheduled, the transit-scheduling server 20 commits the visits to the demand-response transit schedule it maintains. The transit-scheduling server 20 communicates data for the scheduled trips to the resource-scheduling server 28. This data includes a pick-up time and location, and a drop-off time and location for each trip.

Finally, the resource-scheduling server 28 notifies the home health care professionals and the clients (128). The resource-scheduling server 28 sends visit confirmation data to the mobile devices 56 of the clients, and to the mobile devices 52 of the home health care professionals. In addition, the resource-scheduling server 28 also sends trip details to the mobile devices 52 of the home health care professionals. The trip details may include calendar events for the schedule of the home health care professional.

During the course of a day or week, conflicts in the skill-based resource schedule can occur. For example, when a home health care professional is sick, or a client may cancel a visit or ask that a visit be rescheduled. In either of these cases, the home health care professional or the client may call the home health care organization to either speak with an agent or interact with an interactive voice recognition (“IVR”) application to note the issue and request rescheduling or cancellation of a visit. The agent and/or IVR application can interact with the skill-based resource-scheduling software to enter the information. Alternatively, the client can interact with the client application executing on the mobile device 56, or the or home health care professional can interact with the home health care application executing on the mobile device 52 to note the issue and request rescheduling or cancellation of a visit. The home health care application can then relay the information to the resource-scheduling server 28. Additionally, the demand-response transit operator may experience issues with a vehicle or driver and may no longer be able to fulfill one or more scheduled trips. In such cases, the transit-scheduling server 20 may notify the resource-scheduling server 28 that they may be late or may no longer be able to provide the scheduled trip.

Some of these conflicts may result from less discrete events. Another feature of the home health care application executing on the mobile device 52 of the home health care professional and the client application executing on the mobile device 56 of the client is location-tracking and reporting. The mobile devices 52, 56 are able to determine their geolocation, via a GPS radio, and report their geolocation to the resource-scheduling server 28 over the Internet 32. The skill-based resource-scheduling software executing on the resource-scheduling server 28 includes a module for receiving the geolocation of the mobile devices 52 and comparing it to the pick-up location and time for a scheduled trip to estimate whether the home health care professional will be able to meet the vehicle for the scheduled pick-up for the trip. The skill-based resource-scheduling software determines the straight-line distance between the mobile device 52 of the home health care professional and the pick-up location. It then divides this distance by a fastest travel speed parameter to determine the minimum amount of time it would take for the home healthcare professional to arrive at the pick-up location.

Similarly, the module of the skill-based resource-scheduling software executing on the resource-scheduling server 28 includes a module for receiving the geolocation of the mobile devices 56 of the clients and comparing it to the visit location and time to estimate whether the client will be home at the scheduled visit time. The skill-based resource-scheduling software determines the straight-line distance between the mobile device 56 of the home health care professional and the pick-up location. It then divides this distance by a fastest travel speed parameter to determine the minimum amount of time it would take for the home healthcare professional to arrive at the pick-up location.

When any such events are identified by the resource-scheduling server 28 or the transit-scheduling server 20, the resource-scheduling server 28 determines that the skill-based resource schedule is not suitable. As a result, the resource-scheduling server 28 may delay or cancel home visits, and adjust or cancel corresponding trips.

When a client wants to cancel or reschedule a home visit, he or she can interact with the client application on the mobile device 56 to select the target home visit, and then selects to cancel or reschedule it. A client may reschedule a home visit if the client expects to be late, etc. The client may cancel a home visit if the client is not feeling well. Upon indicating that he or she wishes to cancel or reschedule the home visit, the mobile device 56 sends a message to the resource-scheduling server 28. The request for the cancellation or rescheduling of a home visit can alternatively be made by telephone. In either case, the resource-scheduling server 28 cancels the home visit, and sends a message to the transit-scheduling server 20 to cancel trips for the corresponding home health care professional to and from the home visit. The transit-scheduling server 20 cancels these trips and sends a confirmation back to the resource-scheduling server 28 that the trips have been cancelled. Where the assigned home health care professional was scheduled to travel to the home visit from another home visit, or from the home visit to another home visit, the resource-scheduling server 28 requests a new trip for the home health care professional from the transit-scheduling server 20. For example, assume that a home health care professional was previously scheduled to make a trip to client A's home for a home visit, then make a trip to client B's home from the home of client A. The resource-scheduling server 28 can, upon being notified of the cancellation of the home visit for client A, cancel the trip from the home health care professional's home to client A's home, and the trip from client A's home to client B's home. Further, the resource-scheduling server 28 can schedule a trip from the home health care professional's home directly to client B's home. If the transit-scheduling server 20 indicates that a trip from the home health care professional's home to client B's home cannot be scheduled, the resource-scheduling server 28 can decide whether to direct the home health care professional to take alternative means to the house of client B, or to cancel the home visit to client B as well. If the client wishes to reschedule a home visit, then the home visit is rescheduled as a new home visit. Upon revising the resource schedule for the “new” visit, the resource-scheduling server 28 notifies both the client and the home health care professional of the changed schedule.

When a home health care professional wants to cancel or reschedule a home visit, he or she can interact with the home health care application on the mobile device 52 to select the target home visit, and then selects to cancel or reschedule it. A home health care professional may reschedule a home visit if the home health care professional expects to be late, if the home health care professional is not feeling well, etc. Upon indicating that he or she wishes to cancel or reschedule the home visit, the mobile device 52 sends a message to the resource-scheduling server 28. The request for the cancellation or rescheduling of a home visit can alternatively be made by telephone. In either case, the resource-scheduling server 28 cancels the home visit, and sends a message to the transit-scheduling server 20 to cancel trips for the home health care professional to and from the home visit. The transit-scheduling server 20 cancels these trips and sends a confirmation back to the resource-scheduling server 28 that the trips have been cancelled. Where the home health care professional was scheduled to travel to the home visit from another home visit, or from the home visit to another home visit, the resource-scheduling server 28 requests a new trip for the home health care professional from the transit-scheduling server 20. For example, assume that a home health care professional was previously scheduled to make a trip to client A's home for a home visit, then make a trip to client B's home from the home of client A. The resource-scheduling server 28 can, upon being notified of the cancellation of the home visit for client A, cancel the trip from the home health care professional's home to client A's home, and the trip from client A's home to client B's home. Further, the resource-scheduling server 28 can schedule a trip from the home health care professional's home directly to client B's home. If the transit-scheduling server 20 indicates that a trip from the home health care professional's home to client B's home cannot be scheduled, the resource-scheduling server 28 can decide whether to direct the home health care professional to take alternative means to the house of client B, or to cancel the home visit to client B as well. If the client wishes to reschedule a home visit, then the home visit is rescheduled as a new home visit. Upon revising the resource schedule, the resource-scheduling server 28 notifies both the client and the home health care professional of the changed schedule.

Referring again to FIG. 1, the OBU 44 within each vehicle 40 is updated as the schedule for the vehicle 40 is altered by the transit-scheduling server 20. In this manner, the itinerary presented to the vehicle operator via the display of the OBU 44 can be updated in real-time to reflect scheduling changes.

Another feature of the home health care application executing on the mobile device 52 is that it enables the home health care professional to register the start and end of a home visit. When the home health care professional arrives at the home of a client, he or she can indicate that the home visit is commencing via a home visit screen of the home health care application. The home health care application registers the time and geolocation of the mobile device 52 and sends a message to the resource-scheduling server 28 with this information. In addition, when the home health care professional is about to depart form the home of the client, he or she can indicate that the home visit has ended via the home visit screen. Again, the home health care application registers the time and geolocation of the mobile device 52 and sends a message to the resource-scheduling server 28 with this information. This enables the resource-scheduling server 28 to log/register a verification that the home visit was performed and the time that the home visit was performed.

The home health care application can also confirm with the home health care professional the services provided. This additional information can also be forwarded to the resource-scheduling server for billing, auditing and reporting purposes.

The indication by a home health care professional that a home visit is starting or has ended can facilitate billing, auditing or reporting. The resource-scheduling server can generate a report of the home visits for a home health care professional, for a client, or for multiple professionals and/or clients. Confirmation that a home visit can also be provided using the geolocation information registered for each mobile device 52 as intermittently transmitted by the mobile devices 52 and logged by the resource-scheduling server 28.

The geolocation of a home health care professional can be used by the resource-scheduling server in selecting a home health care professional for a home visit where short notice is given.

The resource-scheduling system described above has a number of benefits. Revenue can be increased as a result of more efficient home health care professional scheduling and routing. Home health care professional skills and certifications may be more effectively used. As the interaction with humans to schedule, reschedule and cancel home visits and the corresponding transit trips is reduced, operating costs are lowered and discrepancies between the resource schedule and the transit schedule are reduced. Improved accuracy of home health care professional reporting is achieved, including time spent on activities and distance and time spent traveling. Further, proof of service is provided with the registration of the home health care professional's presence at the client's home. Additionally, the system can reduce the number of no-show clients and home health care professionals as both the home health care professionals and the clients are updated in real-time regarding any schedule changes. Still further, as the transit-scheduling server 20 is automatically alerted of schedule changes, less time is spent by transit operators dwelling at a scheduled pick-up location awaiting for a home health care professional that will not be coming or is significantly late. Agents of the home health care organization no longer have to schedule, reschedule and cancel trips to accommodate the scheduled and cancelled home visits.

Where a client or a home health care professional does not have a mobile device for interacting with the resource-scheduling server, the client or home health care professional can be notified of changes to a scheduled home visit by an agent or the interactive voice recognition system when the client or home health care professional call in to cancel or reschedule an appointment. Similarly, a client or home health care professional that is scheduled for a home visit that is cancelled or rescheduled by the other party can be notified by a telephone call by an agent or a computer, by email, text message, etc.

Computer-executable instructions for implementing the resource-scheduling software, the demand-response transit-scheduling software, the home health care application and the client application on a computing device or computer system could be provided separately from the computing device or computer system, for example, on a computer-readable medium (such as, for example, an optical disk, a hard disk, a USB drive or a media card) or by making them available for downloading over a communications network, such as the Internet.

While the transit-scheduling server and the resource-scheduling server are illustrated and described as single physical computers, it will be appreciated that these servers can include two or more physical computers in communication with each other.

Other methods will occur to a person skilled in the art for determining if a schedule needs to be adjusted in response to information received. For example, other methods can be employed to determine if it appears that the home health care professional, the client or the transit vehicle will be unable to satisfy the schedule within specified acceptable margins.

The above-described embodiments are intended to be examples of the present invention and alterations and modifications may be effected thereto, by those of skill in the art, without departing from the scope of the invention that is defined solely by the claims appended hereto.

What is claimed is:

1. A method for scheduling home health care visits, comprising:
storing, in storage of a computer system, client data for a set of clients, home health care professional data for a set of home health care professionals, and a resource schedule for said set of clients and said set of home health care professionals;
determining that said resource schedule has become unsuitable;
identifying a change to said resource schedule in response to said determining;
automatically communicating said change to a transit-scheduling server to make a revision to a transit schedule;
receiving confirmation of said revision of said transit schedule; and
revising said resource schedule in response to said receiving said confirmation.

2. The method of claim 1, wherein said determining comprises:
receiving a cancellation request for a home visit.

3. The method of claim 1, wherein said determining comprises:
determining that a client scheduled for a home visit will miss said home visit.

4. The method of claim 3, further comprising:
receiving a geolocation of said client from a mobile device associated with said client; and
determining if said client is able to arrive at the location of said home visit at the time of said home visit.

5. The method of claim 1, wherein said determining comprises:
determining that a home health care professional scheduled for a home visit will miss said home visit.

6. The method of claim 5, further comprising:
receiving a geolocation of said home health care professional from a mobile device associated with said home health care professional; and
determining if said home health care professional is able to arrive at the location of said home visit at the time of said home visit.

7. The method of claim 1, wherein said determining comprises:
receiving a notification from said transit-scheduling server that a scheduled trip has been one of cancelled and delayed.

8. The method of claim 1, wherein said revision is associated with at least one trip.

9. The method of claim 8, further comprising:
communicating said revision of said transit schedule to one of said home health care professionals and one of said clients associated with said at least one trip.

10. The method of claim 1, wherein said determining comprises identifying a home visit to be scheduled.

11. The method of claim 10, wherein said automatically communicating comprises communicating an identifier of a client for said home visit.

12. The method of claim 11, further comprising:
revising said change to said resource schedule when said revision is unconfirmed; and
automatically communicating said revised change to said transit-scheduling server to make a revision to said transit schedule.

13. A system for scheduling home health care visits, comprising:
a computer system comprising:
storage storing client data, home health care professional data, a resource schedule and computer-executable instructions for resource-scheduling software;
a communications interface; and
a processor executing said computer-executable instructions and determining that said resource schedule has become unsuitable, identifying a change to said resource schedule, automatically communicating said change to a transit-scheduling server via said communications interface to make a revision to a transit schedule, receiving confirmation of said revision of said transit schedule via said communications interface, and revising said resource schedule in response to said receiving said confirmation.

14. The system of claim 13, wherein said processor determines that said resource schedule has become unsuitable upon receiving a cancellation request for a home visit.

15. The system of claim 13, wherein said processor determines that said resource schedule has become unsuitable upon determining that a client scheduled for a home visit will miss said home visit.

16. The system of claim 15, further comprising:
a mobile device having geolocation-determining technology, said mobile device executing an application for relaying a geolocation determined using said geolocation-determining technology to said computer system,
and wherein said processor of said computer system determines if said mobile device is able to arrive at the location of said home visit at the time of said home visit.

17. The system of claim 13, wherein said processor determines that said resource schedule has become unsuitable upon determining that a home health care professional scheduled for a home visit will miss said home visit.

18. The system of claim 17, further comprising:
a mobile device having geolocation-determining technology, said mobile device executing an application for relaying a geolocation determined using said geolocation-determining technology to said computer system,
and wherein said processor of said computer system determines if said mobile device is able to arrive at the pick-up location of a trip to determine if said resource schedule has become unsuitable.

19. The system of claim 13, wherein said processor determines that said resource schedule has become unsuitable upon receiving notification from said transit-scheduling server that a scheduled trip has been one of cancelled and delayed.

20. The system of claim 13, wherein said revision is associated with at least one trip.

21. The system of claim 20, wherein said processor communicates said revision of said transit schedule to one of said home health care professionals and one of said clients associated with said at least one trip.

22. The system of claim 13, further comprising:
a mobile device executing an application enabling a user thereof to request the cancellation or delay of a home visit, said mobile device transmitting said cancellation or delay request to said computer system.

23. The system of claim 13, wherein said processor requests adjustment of a trip of said transit schedule to a different destination as a result of the cancellation of a home visit.

24. The system of claim 13, wherein said processor requests adjustment of a trip of said transit schedule from a different origin as a result of the cancellation of a home visit.

25. The system of claim 13, further comprising:
a mobile device having geolocation-determining technology, said mobile device executing an application for intermittently relaying a geolocation determined using said geolocation-determining technology to said computer system,
and wherein said processor of said computer system logs said geolocation.

26. The system of claim 13, wherein said processor tracks transit expenditures for clients and benefit plans.

27. A system for scheduling home health care visits, comprising:
a mobile device having geolocation-determining technology, said mobile device executing an application for enabling a user thereof to register the geolocation determined using said geolocation-determining technology at the start and end time of a home visit, and for relaying said start and end times together with said geolocations; and
a computer system receiving and registering said start and end times together with said geolocations.
